(19) United States
(12) Patent Application Publication
(10) Pub. No.: US 2005/0075923 A1
(43) Pub. Date: Apr. 7, 2005

(54) Method and apparatus for managing product planning and marketing

(75) Inventors: James D. Kolsky, Modesto, CA (US); Jennifer J. Wiseman, Modesto, CA (US); Steven C. Sprinkle, Danville, CA (US); Ernest J. Gallo, Dublin, CA (US)

Correspondence Address: MARSHALL, GERSTEIN & BORUN LLP, 6300 SEARS TOWER, 233 S. WACKER DRIVE, CHICAGO, IL, 60606, US

(73) Assignee: E. & J. GALLO WINERY, Modesto, CA (US)

(21) Appl. No.: 10/970,490

(22) Filed: Oct. 21, 2004

Related U.S. Application Data
(63) Continuation-in-part of application No. 10/389,348, filed on Mar. 14, 2003.

(51) Int. Cl. G06F 17/60

(52) U.S. Cl. 705/10

(57) ABSTRACT

Wine characteristic data is related to consumer liking data to provide a predictive model that may be used in wine portfolio management, including selection, shelf placement, pricing, and promotion. The wine characteristic data may relate to wine attributes as determined by a trained panel of experts or by chemical analysis, or to production or process data or to a combination of these data. The consumer liking data may be hedonic data obtained from consumer tasting. The predictive model may be a determined statistical relationship between the characteristic data and the hedonic data. In application, the predictive model may be used to identify what wines will appeal to various consumer segments. Alternatively, the predictive model may be used to identify for particular consumer segments or even individual consumers wines that may be liked.

This application is a continuation-in-part of U.S. patent application Ser. No. 10/389,348 filed: Mar. 14, 2003.

### TECHNICAL FIELD

This patent relates to the field of product planning and finds application in product development, production, distribution and marketing.

### BACKGROUND

Wine, like no other product, offers the consumer an extensive array of choices. For example, the number of stock keeping units (SKUs) for wine at a grocery store with just a modest selection far exceeds the number of SKUs for any other product carried by the store. This is because high quality, reasonably priced wines from around the world are becoming increasingly available to consumers and are now carried through many popular distribution channels including wine specialty stores, member stores, gourmet grocers and large chain grocery stores. The wine industry in the last decade has experienced an increase in the number of wineries, brands, wine styles and retail outlets.

More than almost any other product, wine also challenges, intimidates and frustrates consumers. Wine sellers, anxious to provide consumers with the widest possible selection of labels and styles at wide ranging prices ask the wine producers for more of everything. The result is what has been referred to as the “Wall of Wine” syndrome where the consumer is left staring at what seems to be an endless wall of wines not knowing which have the taste characteristics he or she likes. The stress associated with the wine purchase is exacerbated by the social perception associated with wine and consumer fear of making an improper selection. Wine magazines and other ranking systems, while seemingly providing guidance to the consumer, in many instances only add to consumer confusion. This is because the rankings are based only upon attributes of the wine as perceived by one or more wine “experts,” and do not inform the consumer about whether or not he or she will actually like the taste of the wine. Their utility is further limited because they evaluate only a small percentage of the wines available to consumers, typically the more expensive wines.

As a result, many consumers purchase wines without much knowledge of wine styles and taste characteristics, which may lead them to have a bad buying experience, i.e., not liking the purchased wine. The results can vary from the consumer discounting all wines from that particular winery, and hence the winery losing a potential long term customer, to the consumer concluding he or she simply does not like wine, and the wine industry as a whole losing a potential long term customer. Other consumers have a liked wine or wine style, and never attempt to explore or discover new wines and different styles. A reason for such behavior may be simply not knowing what other wines or wine styles they may like and therefore choosing to stick with a known quantity. As a result, these consumers may not purchase as much wine as they might if they had reliable guidance and confidence in expanding their selection of wines.

One solution to the problem of guiding consumer wine purchases is to provide a trained floor person at the wine retailer. This person could inquire of the consumer's taste preferences and recommend wines the consumer may like. However, it requires trained, knowledgeable persons to be on staff, and therefore may be cost prohibitive for most retailers with the possible exception of the wine specialty retailer. Another possible solution is to provide information that would allow the consumer to choose wines based on liking.

The development of preference analysis, and especially food preference analysis, has interested many scientists involved in food science, psychology, physiology, sociology, anthropology and even statistics. Their research shows that few taste preferences are innate, e.g. sweet; and most of the taste and flavor preferences are developed along with the growth of the child. Many factors influence the development of preference patterns, including the cultural, social and religious environment in which the child is raised. For example, the taste of beer, especially its bitterness, is objectionable to most young adults, however, peer pressure leads many of them to drink beer, even if they do not like it, so that they are acknowledged by their peers.

Familiarity with a food or flavor has been shown to relate to consumer preferences; highly liked foods in the USA are hamburgers, cheese, etc. Flavors such as mango and kiwi were initially rejected, but as they became increasingly available, more consumers tried them, and the growth of kiwi and mango flavored products grew. Thus, consumers tend to reject new flavors at the first exposure (neophobia phenomenon) but can develop a preference for this new flavor over repeated exposures.

In addition, food flavor complexity has an impact on preference development, since some consumers like what they perceive to be a simple flavor while others like the intrigue of a complex flavor containing what they perceive as the smell and taste of several flavors in their food. Their preference is related to their ability to identify different flavors and/or to their gender. There are tasters that like to analyze flavors and there are tasters that like to synergize flavors.

The development of taste preference for wine, i.e., to prefer one wine over another or to prefer wine over another beverage, is certainly influenced by the same factors, but also by the sociology in which wine was first introduced. Many consumers grow up in wine producing areas, such as in France, Italy or Spain, and become familiar with wine and wine culture since it is part of the family lifestyle: like many foods, wine was a part of their every day lives. In non-wine producing areas, consumers tend to discover wine and wine culture in their young adulthood. They have to learn by themselves about wines and wine tasting by reading specialized magazines or attending wine education courses, which are now popular in Europe and North America. As a result, knowing the consumers for whom winemakers make wines goes beyond simple demographic statistics. Moreover, the nature of wine itself contributes to consumer uneasiness during the purchasing process. Wine, unlike many food products that are made to recipe, is not a static product, but instead can change from vintage to vintage or a vintage can change over time. This means that the flavor profile of a wine may change from year to year, which can leave even a relatively knowledgeable consumer still guessing as to what wine to purchase.

Traditionally, in the wine industry, the winemakers, production, and marketing interact to decide on blends. Indeed, directions to make a new wine style or to improve a current wine are often made by the winemakers themselves, according to the grapes, their perception of quality and preferences of the wine category. This approach is very successful in small wineries, where the winemaker can meet consumers at the cellar or the tasting room, talk about their work, their wines and listen to consumer needs and expectations. However, for larger wineries desiring to reach consumers in domestic and international markets, this approach has its drawbacks, as the winemakers do not have the chance to interact as easily with consumers and receive feedback. Moreover, marketing wine in a global market is a challenge, since globally there is a broad range of consumer lifestyles, attitudes, and likes/dislikes, with which the product must meet.

Additionally, product developers, winemakers, or managers assume that they know what consumers expect, what consumers mean, and what magnitude of difference consumers can detect between two products. These assumptions are made honestly upon the data they have collected through qualitative tests or through feedback from sales staff or from other ‘gatekeepers,’ such as distributors and wine writers. Therefore, product development is driven by what they think is ‘good’ for consumers. Consumer input may be collected on prototype products through hedonic or other testing. However, consumers may have no initial input into the direction and qualities of the developed product. Ordinarily, they merely get to say that ‘they liked it’ or ‘did not like it’ after the fact.

An alternative approach for product development has received increasing attention in the food industry and is truly consumer-driven. This means that consumer input is collected from concept ideation through product optimization to screen prototypes according to consumer liking. These techniques use quantitative methods based on psychophysics principles; the motto is that consumers cannot verbalize why they like or do not like a product, however, they can react to sensory stimuli, such as color, flavor, texture and appearance.

Techniques have now been developed to facilitate an understanding of consumer hedonic responses in terms of objective measurements. These techniques avoid having to interpret consumer language. In practice, products are analyzed for their chemical, flavor and sensory profiles in addition to collecting consumer hedonic responses. By relating these sets of objective measurements with consumer liking scores, the objective parameters (alone or in combination) that drive consumer likes and/or dislikes can be identified; furthermore, the optimal product formulation for a particular consumer segment can be determined.

A current trend in both restaurant and specialty retail distribution of wine is to organize the wine list by taste driven classification to simplify consumer selection. Systems for assisting in such organization of wine lists, for example, the system offered by WineQuest Solutions of Napa California (www.winequest.com), have several limitations. A significant limitation with this methodology is that it requires assumptions to get from wine attributes or wine profiles that allow wines to be organized based upon having similar attributes to identifying whether consumers will actually like the wine and in actuality to identifying wines consumers may dislike. Moreover, this system does not link wine attributes to consumer segments and more particularly to consumer segments that may like wines having particular attributes. Also, because it is not based on consumer tasting, it misses key attributes that drive liking and disliking, and primarily picks wines based on what is not liked. It also relies on trained staff to interact with the consumer in the selection process, which can be cost prohibitive.

Other systems attempt to predict what the consumer will like based upon other liking preferences. For example, a system offered by YumYuk.com (www.yumyuk.com) quizzes the consumer regarding various taste preferences. The quiz results are then used to guide the consumer to wines the consumer may like. The YumYuk process, however, relies on the WineQuest technology to organize wines. As a result, it primarily predicts wines that consumers will not like, and then only by assumption. Once again, consumer liking data is not linked to wine attributes to predict wines that the consumer may like.

Thus, some are beginning to address the weaknesses in current techniques by developing classification systems that look at the universe of wine characteristics and consumers and “select” wines and wine style for consumers based on assumptions about what consumers do not like about wines. These techniques are inherently of limited utility because they fail to facilitate getting wines to consumers that are very probably going to be liked by the consumer. That is, in the wine industry there still does not exist either the technology or the techniques linking wine attribute data with consumer liking data for assisting in wine portfolio management including managing selection, shelf placement, pricing and promotion.

### BRIEF DESCRIPTION OF THE DRAWINGS

FIG. 1 is a block diagram illustrating the development of a predictive model.

FIG. 2 is a chart illustrating a wine profile.

FIG. 3 is a chart illustrating consumer segmentation.

FIG. 4 is a chart illustrating predictive model coefficients.

FIG. 5 is block diagram illustrating a first use of the predictive model.

FIG. 6 is a chart illustrating wine mapping based on a predictive model.

FIG. 7 is a block diagram illustrating a second use of the predictive model.

FIG. 8 is a schematic illustration of a wine bottle and label.

FIGS. 9A and 9B depict maps arranging wines by similar liking characteristics

FIG. 10 is a schematic illustration of a retail product display and purchase guide.

FIG. 11 is a block diagram illustrating a data network.

FIG. 12 is a block diagram illustrating a computer and database structure.

### DETAILED DESCRIPTION

Wine characteristic data is related to consumer liking data to provide a predictive model that may be used in wine portfolio management, including selection, shelf placement, pricing, and promotion. The wine characteristic data may relate to wine attributes as determined by a trained panel of experts or by chemical analysis, or to production or process data or to a combination of these data. The consumer liking data may be hedonic data obtained from consumer tasting. The predictive model may be a determined statistical relationship between the characteristic data and the hedonic data. In application, the predictive model may be used to identify what wines will appeal to various consumer segments. Further, the model may be used to identify wines having similar liking characteristics to consumers. Alternatively, the predictive model may be used to identify for particular consumer segments, or even for individual consumers, wines that may be liked.

The wine portfolio, either at the winery or at the wine seller, such as stores or restaurants may be managed using the related wine characteristic data and hedonic data represented within the predictive model. Wine offerings, i.e., selection may be determined, retail space or the wine list may be arranged, whether physically or virtually, e.g., via Internet-based sale and distribution, pricing and discounting may be set and promotions developed based upon the predictive model. Guide information explaining the arrangement of the wines within the retail space or on the wine list may be displayed at the wine seller or otherwise communicated to the consumer, and information may be provided, in the form of printed materials, personal advice, interactive media, or the like, to allow a consumer to determine the kinds of wines that may appeal to them. Further, the predicted liking relationships between wines can be by graphical depictions, maps or by means of codes selected from the group consisting of color codes, number codes, letter codes, graphic codes and iconic codes. Such use of the predictive model may lead to reduced consumer stress in the wine selection process, will allow consumers to select wines they are more likely to like and may facilitate consumer exploration and discovery of new wine brands and styles. Wine sellers may be able to more easily determine what wines to keep in their selection, how to price the wines, and when and to whom to target promotions. Wine sellers lacking the facility or capability to provide trained staff to assist customers in wine selection may benefit in that consumers will be able to self-determine recommended wines based upon their own likings or upon other consumer characteristics which can be determined by querying the customer. Thus, these wine sellers may be able to better compete with specialty retailers. Most importantly, consumers will be able to confidently choose wines they like, to discover new wines and to ultimately purchase more wine.

Wine producers may benefit from the use of the predictive model to plan wine production and to assist distributors and retailers relative to maximizing sales. This, in turn, will provide opportunities for wine producers to maximize sales.

As described herein in connection with several exemplary embodiments, a predictive model linking consumer wine liking data and wine characteristic data, such as sensory, chemical attribute, production or processing data, may be defined using a suitable statistical software tool such as the SPSS® software product available from SPSS, Inc. or The Unscrambler™ software product available from CAMO, Inc. One of ordinary skill in the art will appreciate that there are other commercially available software tools that will facilitate the data analysis described herein. Moreover, it is understood that the predictive model itself may be a software tool that may run within an environment provided by the aforementioned statistical software tools and/or in a stand alone manner on a suitable computing platform such as a Windows based computer system.

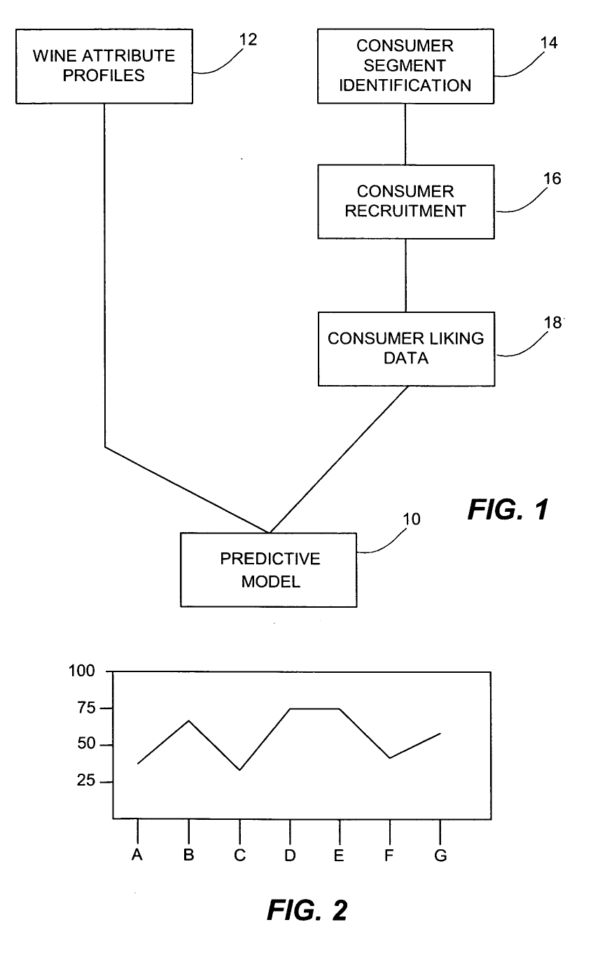

FIG. 1 illustrates a process for defining a predictive model 10 linking consumer wine liking data and wine characteristic data. The block 12 represents a process whereby attribute profiles are developed for a number, N, of wines. An expert panel is assembled and trained. The training, preferably, may be relative to fixed, known standards or the training may be to previously characterized wines or by other techniques. The expert panel may be a permanent group, i.e., its members are fixed and expected to participate regularly. The expert panel creates a profile for each of the N wines rating each of a number of sensory attributes, such as basic taste, aromas, mouth texture, etc. Sensory attributes typically used to profile wine are well known to one having ordinary skill in the art. Each of the attributes is given a value for the wine, which represents the average of the values assigned by each of the panel members. FIG. 2 illustrates a profile for a wine, wherein the average values of each of the attributes A-G, between 0 and 100, representing the relative intensity of the characteristics as rated by the panelists. While a number of attributes are indicated in FIG. 2, it will be appreciated that there may be many additional attributes that are not represented in the profiled wine. One of ordinary skill in the art will be able to readily identify the plurality of wine attributes commonly used to characterize a wine. Alternatively, chemical analysis may be used to determine chemical attributes of the wine or production or winemaking process data may be used to evaluate wines. Therefore, sensory attributes, chemical attributes, production or process data or combinations thereof may be used to provide the wine profile.

To ensure consistent results from the panelists, statistics on the performance of the panelists may be kept. Such statistics may analyze variability in the attribute values assigned by panelists. The statistics may be used to remove a panelist or to provide additional training. As chemical analysis techniques are enhanced, sensory ratings by the expert panel may be supplemented with such chemical attribute data.

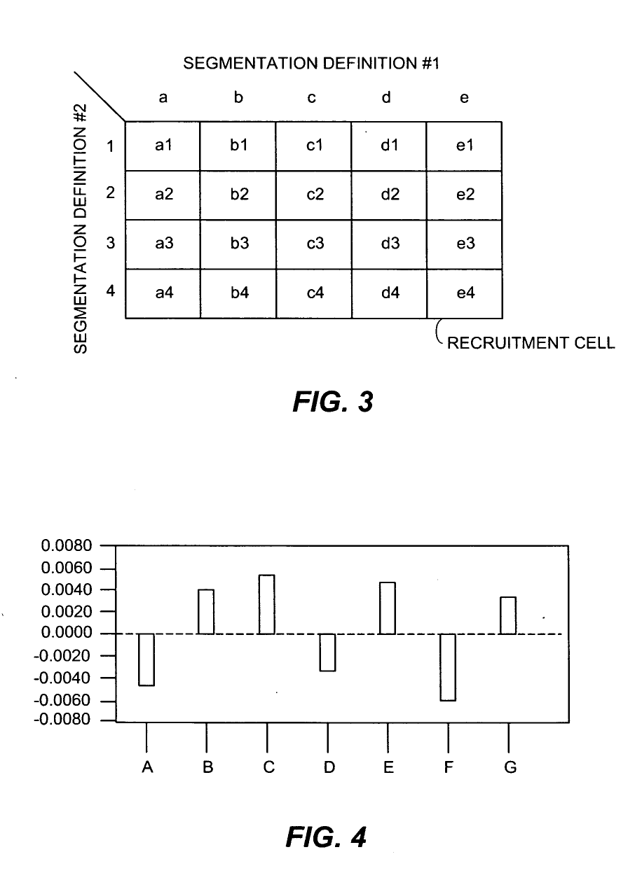

The block 14 represents a process by which consumer segments are identified and recruited. A number of segmentation definitions may be identified such as: shopping behavior, lifestyle, geography, purchase price points, etc. FIG. 3 illustrates recruitment cells based upon a plurality of segmentation definitions a-e and 1-4. In the process for defining the predictive model 10, it is possible that a wide array of consumers will be recruited without regard to segmentation definitions. However, consumers may be recruited according to particular segmentation cells, which is represented by block 16. Recruitment of consumers by segment, and the subsequent gathering of liking data according to the segments, facilitates relating of the liking data with the wine profile data, and more particularly to ensuring the predictive model will predict wines that will be liked by consumers that meet the segment definition. It is possible to obtain the liking data without first recruiting consumers according to segments. However, the cost may be prohibitive. An extremely large number of consumers would have to be recruited to ensure that sufficient numbers of consumers are identified in each segment. Still, it is possible to collect consumer liking data on an ongoing basis by soliciting consumer feedback, potentially after an initial predictive model has been created using recruited consumer data. This collected. consumer data, for example obtained via loyalty card programs, wine club solicitations and the like, may be used subsequent to the creation of the predictive model to verify continued accuracy of the predictive model or to dynamically adjust the model by periodic recalculation of the model parameters. For example, if partial least squares (PLS) techniques are used in creating the predictive model as described below, recursive PLS techniques may be used for updating.

The block 18 represents a process by which the recruited consumers for each of the segmentation cells taste a subset of the N wines and provide a liking score for each of the tasted wines. The liking score may be on a hedonic scale of 1-9, where 9 represents most liking and 1 represents most disliking. The recruited consumers taste only a subset of the wines to speed the process and to reduce cost. Alternatively, each recruited consumer may taste all N of the wines. Between all of the consumers in the recruited cell, however, all of the N wines are tasted. Moreover, each of the wines is tasted by approximately the same number of consumers, and the number of wines in each of the subsets is substantially the same. That is, consumer A tastes N₁, of the X wines, while consumer B tastes N₂ of the X wines. The set N1 of wines is different than the set N2 of wines, however, the sets need not be mutually exclusive, and in most instances will not be.

As will be appreciated from the foregoing described tasting regime, there will be missing data points for the consumer liking data, i.e., each consumer may not taste all N wines. Suitable gap filling techniques are used to form a complete set of liking data for each consumer. For example, an expectation algorithm may be used to complete the data set assuming the liking data is normally distributed. Next, the data is manipulated to remove scale effect. This is accomplished for the data for each consumer by subtracting the average liking value from the individual liking scores.

A clustering algorithm is then used to cluster the consumer liking data. For example, a k-means clustering algorithm may be used. Several different clustering criteria may be run to obtain a predetermined number, M, of taste clusters. The cluster size minimum may be approximately 30-35 consumers in each cluster, although the cluster sizes may vary depending on the availability of consumers and the degree of segmentation desired. For example, it is possible that cluster size could be reduced to one (1) consumer per cluster. In that case, the resulting predictive model would be predictive of wine liking for that one consumer. The clusters are determined using the “filled” consumer liking data. Once a suitable set of clusters is determined, the average liking score for each wine is then determined for each cluster. The average liking score may be based only on the “observed” consumer liking data, or the “filled” data may be used.

To determine the predictive model 10, a partial least squares, or other suitable statistical correlation approach, may be used to identify the attributes that contribute to liking in view of the cluster liking data. The panel attributes may be evaluated singly, pair wise, as quadratic effects, or in other various combinations. The result is a set of coefficients (FIG. 4), representing those attributes that contribute to consumer liking for a cluster keeping in mind that the liking data was generated based upon recruited consumer segments so that it is known that each of the desired consumer segments is represented in the data. Thus, the predictive model 10 is predictive of liking for the consumer population defined by the recruited consumer segments. As noted, it is not necessary to conduct liking testing using recruited liking cells, but this ensures the desired consumer segments are represented in the data, and reduces the overall number of consumers recruited to provide the data.

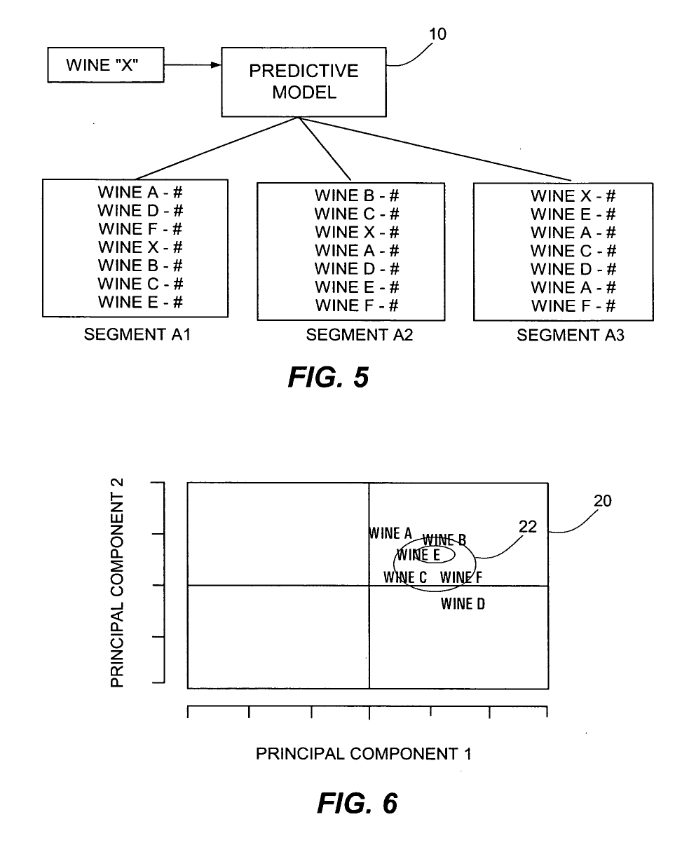

The predictive model 10 may consist of a number of predictive models determined based upon liking data for each of the various consumer segments. The predicative model 10 may then be used to predict whether a particular wine will be liked by a particular consumer segment. This process is illustrated in FIG. 5, wherein panel determined attributes of a wine X are provided to the predictive model 10. The attributes are then multiplied by the model coefficients (FIG. 4), and a predicted liking score (Wine X-#) is determined for the corresponding consumer segment. As shown in FIG. 5, the score may be ranked relative to other wines for particular consumer segments. For example, wines A-F may be shown with their respective liking scores. These wines may be the wines used to create the predictive model or wines subsequently evaluated.

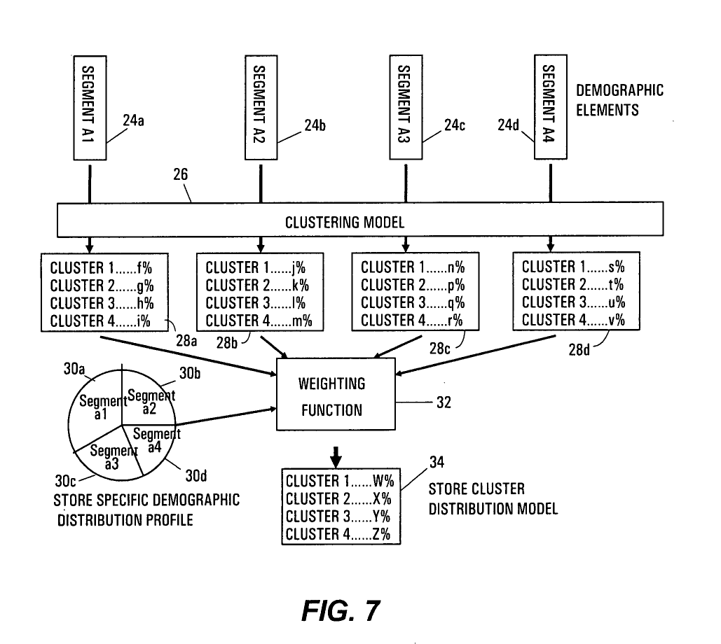

As shown in FIG. 6, a map 20 may be used to graphically depict the liking data using principal components analysis. A first and second principal component form the X and Y axes of the map 20. Each wine is then depicted on the map 20 based upon the principal components. To assist in viewing the clusters of wines, contours 22 may be depicted on the map 20 indicating wines that have similar liking characteristics. While the principal component analysis depicted in FIG. 6 synthesizes data reflecting wine attributes into two dimensions and liking data into a third dimension (depicted by contours) those of skill in the art would recognize that additional variables could be used to depict wine attributes and liking data. Further, such variables could be depicted in graphically, iconicly or by means of a code such as a color, numeric or letter code.

FIG. 7 illustrates the stage of the predictive model 10 for clustering the consumer liking data. The liking data for the various consumer segments 24a, 24b, 24c and 24d, corresponding respectively to segments a1, a2, a3 and a4, are submitted to a clustering function 26, such as a k-means clustering algorithm, to provide corresponding wine liking cluster data, 28a, 28b, 28c and 28d. The cluster data 28a, 28b, 28c and 28d may then be statistically combined with the sensory and chemical attribute data to generate the predictive model 10.

Further shown in FIG. 7, is market segment data, e.g., consumer segment data for a particular store or group of stores or for a region or regions, 30a, 30b, 30c and 30d, the segments 30a, 30b, 30c and 30d corresponding to the consumer segments a1, a2, a3 and a4. The segment data 30a, 30b, 30c and 30d represents the number of consumers for the market that fall into each of the segments a1, a2, a3 and a4 for that market, the pie chart illustration generally indicating relative sizes of the segments. The data may also be represented as a percentage. The segment data 30a, 30b, 30c and 30d are provided to a weighting function 32 along with the cluster data 28a, 28b, 28c and 28d. The output of the weighing function 32 is market specific, weighted cluster data 34. An exemplary weighting is a straight weighing function consisting of:
W %=(f %*30a+j %*30b+n %*30c+s %*30d)/(30a+30b+30c+30d)
X %=(g %*30a+k %*30b+p %*30c+t %*30d)/(30a+30b+30c+30d)
Y %=(h %*30a+l %*30b+q %*30c+u %*30d)/(30a+30b+30c+30d)
Z %=(i %*30a+m %*30b+r %*30c+v %*30d)/(30a+30b+30c+30d)
A market specific predictive model may then be created using the weighted cluster data 34.

The predictive models based upon consumer liking data and wine attribute data, as described herein, may be used for portfolio planning at producer and retail levels, to manage distribution, to manage selection, to set pricing and to focus marketing. From a production planning perspective, the predictive model may identify whether wines predicted to be liked by a particular consumer segment or market are represented by a sufficient number of offerings. If there are gaps representing a potential opportunity, this information may be provided to the winemakers who may then work to produce a wine or move a wine or wines to meet that need. The predictive model is based upon and represents the wine attributes that contribute most to liking for a particular consumer segment. Thus, the winemaker is informed as to what attributes to enhance in the wine to move the wine into a cluster liked by a particular consumer segment.

The predictive model concept, and particularly its relationship to consumer liking data, may be leveraged to focus retail marketing activity and to coordinate distribution of wine accordingly. The predictive model 10 has a number of capabilities. It can identify consumer segments that may like a particular wine based upon its attributes. The attributes are accurately determined using the trained expert panel. This attribute data is reliably obtained, checked and verified using statistical techniques. Knowing the consumer segments that may like a particular wine can allow the wine producer or distributor to advise various retail outlets what wines to keep in its selection, how to set prices and what and when to promote or to advertise (media or in-store).

The predictive model concept may be used to customize promotional offerings for wines that wine sellers know consumers are likely to like. Information about consumers may be developed from loyalty card or similar data, e.g., purchased third party individual consumer or consumer segment data, and the predictive model used to relate that data to liking data to customize promotions and to direct those promotions to particular consumers. For example, the promotion may indicate availability of particular wines or wine styles or special promotional pricing. It may allow the wine seller to promote to those consumers wines the consumer may like, to suggest wines that may allow the consumer to explore and discover and to use wine promotion in combination of other products or services the consumer may desire. More importantly, the predictive model concept may allow the wine seller to minimize or eliminate bad wine buying experiences by the consumer, enhancing the consumer's appreciation for wine and ultimately wining the consumer's confidence and increasing sales.

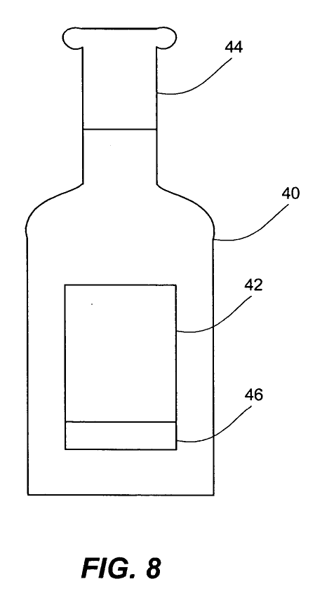

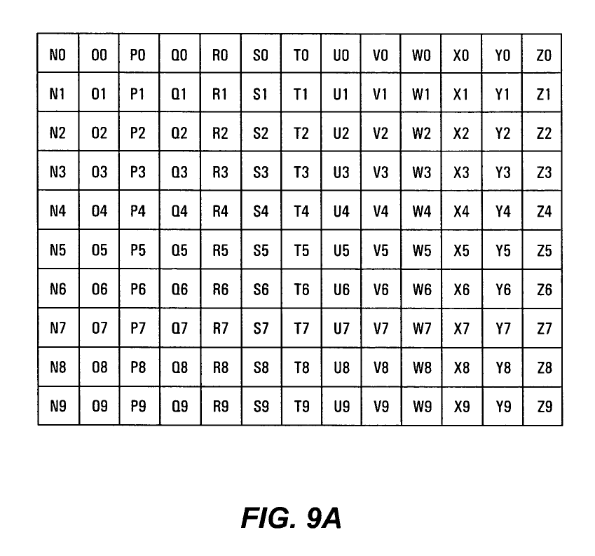

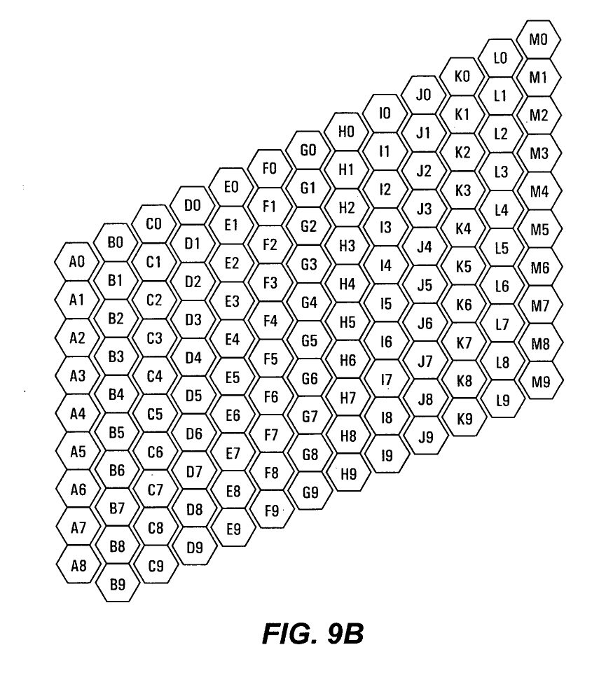

The predictive model concept may also be used to change the manner in which the wine seller presents wines to consumers in stores and restaurants. The predictive model provides the capability to identify a liking cluster or clusters. Thus, the wine may be coded to identify the cluster or clusters to which it belongs. FIG. 8 illustrates a wine bottle 40 with a label 42 and cap 44. The label 42 may include a portion 46 representing the wine cluster. For example, a color code, number code, letter code, graphic or iconic or any suitable code may be used to identify the cluster or clusters to which the wine should appeal. Multiple codes may be provided in the portion 46, for example multiple colors depicted, multiple letters or number, or iconic representations. It is possible, if color coding is used, for the cap 44 to be made the appropriate color or colors to represent the cluster thus allowing the consumer to quickly and easily recognize the cluster. Alternatively, a “necker” (not depicted) may be applied to the wine bottle 40 to identify the clusters. Still further, wines having similar liking characteristics to a consumer may be identified to consumers by visually identifying the liking relationships. Such liking relationships can be graphically depicted such as on a map and may also be depicted by means of color, number and letter codes. FIGS. 9A and 9B depict such maps in which wines having similar liking characteristics are arranged alphanumerically as well as by hue, intensity and value of color. FIG. 9A depicts such a map for red wines while FIG. 9B depicts a map for white wines. Wines are assigned particular locations on the map characterized by various color, number or letter codes. Thus, wines having similar numbers, letters and colors would be recognized by a consumer as having similar liking characteristics. According to a preferred aspect of the invention the maps are presented having gradations of one or more color hues across their various dimensions. Thus, the map of FIG. 9A depicting liking relationships among red wines might be a deep red at the NO grid fading to a near white at the Z9 grid. At the same time grid Z0 is a deep yellow and grid N9 is purple with each of the map grids in between characterized by a blend of those hues. An analogous color scheme using greens, blues, reds and purples could be used for white wines in FIG. 9B.

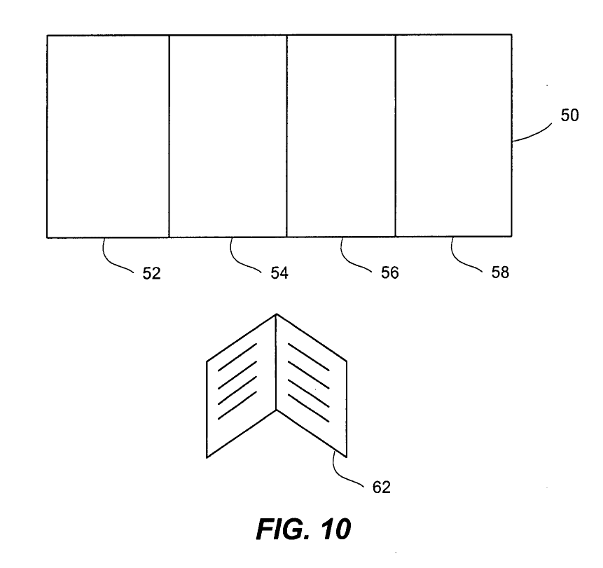

FIG. 10 illustrates a retail wine outlet having store shelving 50. The store shelves may be divided into clusters 52, 54, 56 and 58. Of course more or fewer clusters may be provided. Wine may be stocked on the shelving 50 based upon the clusters. A consumer guide 62 may be provided that describes the clusters and directs the consumer to particular clusters. The guide 62 may be printed media, or could be an interactive kiosk with a suitable screen, input device and a processor (not depicted). The screen and input device may be combined such as with a touch screen. The consumer may be queried via the screen and input device, and a liking cluster or clusters suggested. The consumer would also be informed of the corresponding cluster codes. The consumer may then confidently select a wine from the suggested clusters and in the consumer's desired price range. The consumer guide may also be available to the consumer via the Internet. It will be understood that a wine may appeal to multiple clusters, thus requiring the wine to be stocked in multiple locations. However, it may be difficult to overcome the traditional arrangement of wines by wine style. Thus, the use of label or other suitable coding on the wine product itself may eliminate redundant placement of wine product on the store shelves, and may allow retailers to preserve the traditional arrangements of wines by wine style while still allowing the consumer to benefit from the use of the predictive model. The coding may additionally appear on price tags or shelf talkers.

To be most effective for consumers, and as alluded to above, information may be provided to the consumer that allows each consumer to self-profile to determine what cluster or clusters of wine may appeal to them. For example, the guide 62 may include a questionnaire that will allow the consumer to determine his or her cluster. The questionnaire may be presented in the form of a decision tree or flow chart. Alternatively, the guide may be made interactive, such as an interactive kiosk with an input device, such as a touch screen display or mouse. The questionnaire may inquire of the consumer's demographics, the consumer may be asked to taste and provide liking scores for a selection of wines or combinations of these techniques may be used to identify corresponding clusters.

The predictive model concept may also be used to help retailers balance wine selection/offerings. Retailers will be able to identify wines that appeal to particular consumer segments through use of the predictive model. Furthermore, the retailer will be able to stock wines that may potentially appeal to its predominant customer base, thus allowing it to adjust its selection of wines in particular price ranges to better appeal to consumers and allowing its consumers to discover new wines. The retailer may also use the predictive model to manage the shelf life of the wine inventory. Wine changes with time, thus over time the clusters a wine belongs to may change, and hence, the consumers segments that the wine may appeal to may change. The retailer may use the predictive model to alter promotions to target the wine to different consumer segments or may make recommendations to the consumer such as to buy and drink or to buy and hold certain wines. The wine producer will also be positioned to take a proactive role with its distributors and retailers by providing them with information that can be used to make more informed wine stocking decisions.

Periodic maintenance of the predictive model may be needed to ensure that the correlation between the wine attributes and the consumer liking data remains. One approach is to evaluate the predictive capability of the model relative to real-world data. Additional products, i.e., wines, may be evaluated to develop corresponding profiles. The predictive model may then be used develop liking scores for these wines for particular consumer segments. These wines may then also be tasted by consumers originally recruited for particular consumer segments, and liking data obtained. These liking scores can then be compared to model predictions. Large shifts in the data are suggestive of a need to revise the model.

Store loyalty data, or other sources of purchase data, e.g., scanner data and the like, may be used as an indication of wine purchasing habits by consumers. The store loyalty data typically also includes consumer demographic data. Scanner data may be related to store demographics. Thus, it may be possible to examine sales volume correlated with consumer characteristics taken either from loyalty card, store demographics, purchased third party compiled or similar data, and to use the predictive model to identify opportunities for the wine seller. To the benefit of the consumer, the predictive model data will assist in identifying wines having a high potential for being liked by consumers meeting the characteristics of those that purchase from the wine seller. Thus, the wine seller may adjust selection to provide a better wine buying experience for the consumer and to eliminate negative reinforcement or bad purchasing experiences, thereby increasing sales by enabling consumers to have better wine experiences.

As described above, consumers, recruited for particular segments, are used to generate liking data. Market, e.g., geographic region, store, restaurant or the like, specific demographic data may be gathered, along with purchase data from the wine seller. Liking data may be derived from this demographic and purchase data, and used in the creation of the predictive model or to provide a weighting factor to existing models. In this application, market specific predictive models may be created or existing predictive models adapted for the particular market.

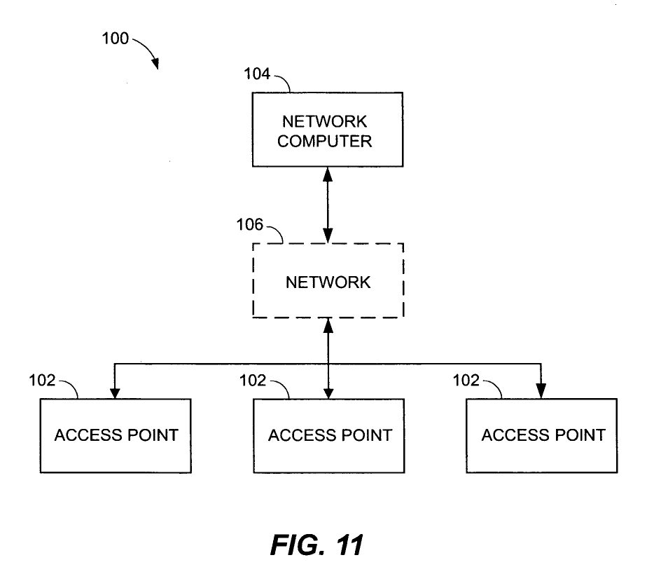

FIG. 11 illustrates an embodiment of a data network 100 including a first group of access points 102 operatively coupled to a central or network computer 104 via a network 106. The plurality of access points 102 may be located, by way of example rather than limitation, in separate geographic locations from each other, in different areas of the same city, or in different states or countries. The access points, for example, may be located at wine seller locations and may be operatively coupled to the wine seller's information management systems to collect and communicate scanner data, purchaser data and the like and communicate it back to the network computer 104. The access points 102 may be located at consumer locations to allow consumers to provide liking data, as part of the data gathering process in creating the predictive model or as part of ongoing data gathering and information sharing as part of maintenance of the predictive models or to allow consumers to use the facilities of the predictive model.

The network 106 may be provided using a wide variety of techniques well known to those skilled in the art for the transfer of electronic data, and may include the Internet. For example, the network 106 may comprise dedicated access lines, plain ordinary telephone lines, satellite links, combinations of these, etc. Additionally, the network 106 may include a plurality of network computers or server computers (not shown), each of which may be operatively interconnected in a known manner. Where the network 106 comprises the Internet, data communication may take place over the network 106 via an Internet communication protocol.

The network computer 104 may be a server computer of the type commonly employed in networking solutions. The network computer 104 may be used to accumulate, analyze, store, download and communicate data relating to the predictive model, e.g., the predictive model 10. In this regard, the network computer 104 may periodically receive data from the expert panel members, from recruited consumers, wine sellers, wine producers, and the like relating to the creation and use of the predictive model.

Although the data network 106 is shown to include one network computer 104 and three access points 102, it should be understood that different numbers of computers and access points may be utilized. For example, the network 106 may include a plurality of network computers 104 and literally thousands of access points 102, all of which may be interconnected via the network 106. According to the disclosed examples, this configuration may provide several advantages, such as, enabling near real time uploads and downloads of information as well as periodic uploads and downloads of information. This may also provide a primary backup of all information generated in the process of updating and accumulating data relating to the creation and use of the predictive model.

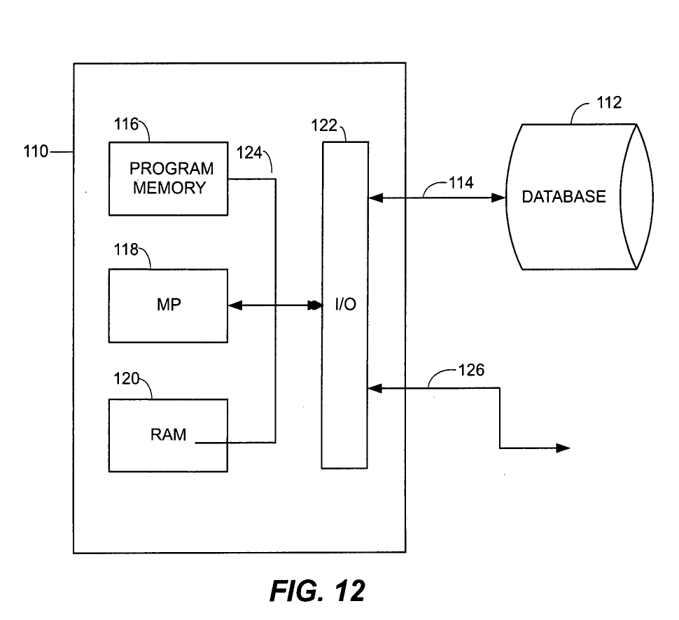

FIG. 12 is a schematic diagram of one possible embodiment of the network computer 104 shown in FIG. 11. The network computer 104 may have a controller 116 that is operatively connected to a database 112 via a link 114. It should be noted that, while not shown, additional databases may be linked to the controller 110 in a known manner.

The controller 110 may include a program memory 16, a microcontroller or microprocessor (MP) 118, a random access memory (RAM) 120, and an input/output (I/O) circuit 122, all of which may be interconnected via an address/data bus 124. It should be appreciated that although only one microprocessor 118 is shown, the controller 110 may include multiple microprocessors 118. Similarly, the memory of the controller 110 may include multiple RAMs 120 and multiple program memories 116. Although the I/O circuit 122 is shown as a single block, it should be appreciated that the I/O circuit 122 may include a number of different types of I/O circuits. The RAM(s) 120 and program memories 116 may be implemented as semiconductor memories, magnetically readable memories, and/or optically readable memories, for example. The controller 110 may also be operatively connected to the network 106 via a link 124.

The program memories 116 may contain program code corresponding to the functions of gathering data to create the predictive model as well as to analyze the gathered data in order to determine the parameters of the predictive model. The program memories may also contain software routines or routines to implement the functionality and the uses of the predictive model as described herein.

The predictive model concept allows for fundamentally sound, objective evaluation of wine attributes to be related to consumer liking data to facilitate production, distribution and retail sale of wine products. Although the creation of a predictive model linking wine attribute and consumer liking data and used for wine portfolio management has been described herein as being preferably implemented in software and via a network architecture, it may be implemented in hardware, firmware, etc. and in standalone applications. Thus, the routines described herein may be implemented in a standard multi-purpose CPU or on specifically designed hardware or firmware as desired. When implemented in software, the software routines may be stored in any computer readable memory such as on a magnetic disk, a laser disk, or other storage medium, in a RAM or ROM of the computer or processor, etc.

This patent describes several specific embodiments including hardware and software embodiments of apparatus and methods for creating and using a predictive model combining wine attribute data and consumer liking data. However, one of ordinary skill in the art will appreciate that various modifications and changes can be made to these embodiments. Accordingly, the specification and drawings are to be regarded in an illustrative rather than restrictive sense, and all such modifications are intended to be included within the scope of the present patent.

1. A method of identifying wine attributes corresponding to consumer liking of wines, the method comprising the steps of:
for a plurality of wines, determining for each wine a wine attribute profile to produce wine attribute profile data for the plurality of wines;
identifying a segment of consumers according to at least one consumer criteria;
obtaining data from the segment of consumers for the plurality of wines to produce consumer liking data, the consumer liking data for each consumer being a liking indication for at least a subset of the plurality of wines; and
statistically evaluating the wine attribute profile data and the consumer liking data to identify wine attributes corresponding to wines having high consumer liking indications for the segment.

2. The method of claim 1, comprising the step of determining taste cluster data from the consumer liking data.

3. The method of claim 2, comprising weighing the taste cluster data in view of market data.

4. The method of claim 2, comprising updating the taste cluster data.

5. The method of claim 1, comprising filling missing consumer liking data to form filled consumer liking data.

6. The method of claim 1, wherein the wine attributes profile data comprises at least one of sensory attribute data, chemical attribute data, production data and process data.

7. The method of claim 1, wherein the wine attributes profile data are determined by an expert panel.

8. The method of claim 7, wherein the wine attributes profile data are determined by the expert panel relative to fixed standards.

9. The method of claim 7, comprising statistically tracking the wine attributes profile data determined by the expert panel.

10. The method of claim 1, wherein the wine attribute profile data are determined by chemical analysis.

11. The method of claim 1, wherein the liking indication comprises a liking value provided by a consumer of the segment of consumers, the value being based upon a hedonic scale.

12. The method of claim 1, wherein the step of statistically evaluating the wine attribute profile data and the consumer liking data comprises determining a set of weighting coefficients, the weighting coefficients relating wine attribute data of a subject wine to a liking indication for the segment of consumers.

13. The method of claim 1, wherein the step of obtaining data from the segment of consumers comprises querying consumers via at least one of: interactive kiosk; written questionnaire and on-line questionnaire.

14. The method of claim 13, wherein the step of obtaining data from the segment of consumers comprises obtaining data from consumers outside an initial group of consumers to provide second consumer liking data, and wherein the step of statistically evaluating the wine attribute profile data and the consumer liking data to identify wine attributes corresponding to wines having high consumer liking indications for the segment comprises evaluating the wine attribute profile data, the consumer liking data and the second consumer liking data.

15. The method of claim 1, wherein the step of identifying a segment of consumers comprises identifying consumers of a particular wine seller.

16. The method of claim 1, wherein the step of identifying a segment of consumers comprises identifying a single consumer.

17. A model comprising:
first data representing wine attribute profiles for a plurality of wines;
second data representing consumer clusters and liking indications for the plurality of wines for the consumer clusters; and
third data statistically linking the first data and the second data and representing wine attributes corresponding to wines having a liking indication for the consumer segment.

18. The model of claim 17, wherein the third data comprises wine attribute coefficients, the wine attribute coefficients corresponding to a weighting of wine profile data of a subject wine to provide a liking indication of the subject wine relative to the consumer segment.

19. The model of claim 17, wherein the first data comprises at least one of sensory data, chemical analysis data, production data and process data.

20. The model of claim 17, wherein the second data includes taste cluster data.

21. The model of claim 17, wherein at least one of the first data and the second data comprises updated data.

22. The model of claim 17, wherein the second data comprises hedonic liking data.

23. A method of wine product portfolio management, the method comprising:
using a model of consumer wine product liking to provide first data representing wine product attributes corresponding to wines having high consumer liking indications for particular segments of consumers; and
managing a portfolio of wine product in view of the first data to enhance an availability of wine for a particular consumer segment.

24. The method of claim 23, wherein the step of managing a portfolio of wine comprises identifying a point of distribution of wine for the consumer segment, and managing a selection of wine at the point of distribution based upon the first data.

25. The method of claim 23, wherein the step of managing a portfolio of wine comprises identifying a point of distribution of wine for the consumer segment, and targeting advertising to the consumer segment indicating an availability of wine selected in accordance with the first data at the point of distribution.

26. The method of claim 23, wherein the step of managing a portfolio of wine comprises identifying a point of distribution of wine for the consumer segment, and organizing a display of wine at the point of distribution in accordance with the first data.

27. The method of claim 23, wherein the step of managing a portfolio of wine comprises producing a wine for the consumer segment having attributes based upon the first data.

28. The method of claim 23, wherein the step of managing a portfolio of wine comprises providing a selection of wines for the consumer segment having a set of wine attributes based upon the first data.

29. The method of claim 23, wherein the model comprises a statistical combination of wine product attribute data and consumer liking data.

30. The method of claim 23, wherein the step of managing a portfolio of wine comprises:
obtaining consumer characteristic data from a consumer and suggesting a wine product to the consumer based upon the first data and the consumer characteristic data.

31. The method of claim 30, wherein the step of obtaining consumer characteristic data comprises providing a guide to the consumer.

32. The method of claim 31, wherein the guide comprises at least one of printed materials and an interactive kiosk.

33. A method of managing a wine portfolio, the method comprising:
using a model of consumer wine product liking to provide first data representing wine product attributes corresponding to wines having high consumer liking indications for particular segments of consumers;
obtaining wine seller sales data and wine seller customer data to provide wine seller data; and
managing a portfolio of wine product in view of the first data and the wine seller data to enhance an availability of wine for a particular consumer segment.

34. The method of claim 33, wherein the step of obtaining wine seller sales data comprises obtaining scanner data from the wine seller.

35. The method of claim 33, wherein the step of obtaining wine seller customer data comprises obtaining wine seller loyalty program data.

36. The method of claim 33, wherein the step of obtaining wine seller customer data comprises purchasing consumer data from a consumer data source.

37. The method of claim 33, wherein the step of obtaining wine seller customer data comprises querying wine seller customers.

38. The method of claim 33, wherein the step of managing a portfolio of wines comprises managing a selection of wine at the point of distribution based upon the first data and the wine seller data.

39. The method of claim 33, wherein the step of managing a portfolio of wine comprises targeting advertising to a wine consumer based upon the wine seller data indicating an availability of wine selected in accordance with the first data.

40. The method of claim 33, wherein the step of managing a portfolio of wine comprises targeting a promotion to a wine consumer based upon the wine seller data indicating an availability of wine selected in accordance with the first data.

41. The method of claim 33, wherein the step of managing a portfolio of wine comprises organizing a presentation of wine at the wine seller in accordance with the first data.

42. The method of claim 33, wherein the model comprises a statistical combination of wine product attribute data and consumer liking data.

43. The method of claim 42, further comprising modifying the model in view of market data.

44. The method of claim 43, wherein the step of modifying the model in view of market data comprise weighting the model in view of one of the wine seller sales data and the wine seller customer data.

45. The method of claim 43, wherein the step of modifying the model in view of market data comprise weighting the model in view of one market demographic data.

46. A method of targeting wine product to a wine consumer comprising:
using a model of consumer wine product liking to provide first data representing wine product attributes corresponding to wines having high consumer liking indications for particular clusters of consumers;
obtaining wine consumer data; and
identifying a wine based upon the first data and the wine consumer data.

47. The method of claim 46, further comprising targeting a promotion of the wine to the wine consumer.

48. The method of claim 46, wherein the step of obtaining wine consumer data comprises obtaining wine seller loyalty program data.

49. The method of claim 46, wherein the step of obtaining wine consumer data comprises querying wine consumers.

50. The method of claim 46, wherein the step of obtaining wine consumer data comprises purchasing consumer data from a consumer data source.

51. The method of claim 46, comprising applying indicia to the wine product indicative of the first data.

52. The method of claim 51, comprising providing guide information to the wine consumer regarding the indicia.

53. The method of claim 46, comprising identifying a second wine based upon the first data and advising the wine consumer of the second wine.

54. The method of claim 53, comprising obtain purchasing data for the wine consumer and wherein the second wine comprises a wine not previously purchased by the wine consumer based upon the purchasing data.

55. A method of identifying wine attributes corresponding to consumer liking of wines for a market, the method comprising the steps of:
for a plurality of wines, determining for each wine a wine attribute profile to produce wine attribute profile data for the plurality of wines;
identifying a first segment of consumers according to at least a first consumer criteria;
obtaining data from the segment of consumers for the plurality of wines to produce consumer liking data, the consumer liking data for each consumer being a liking indication for at least a subset of the plurality of wines;
identifying a second segment of consumers according to at least a second consumer criteria including a propensity to obtain wine product within the market to provide market data;
revising the consumer liking data based upon the market data to create revised consumer liking data; and
statistically evaluating the wine attribute profile data and the consumer liking data to identify wine attributes corresponding to wines having high consumer liking indications for the market.

56. The method of claim 55, wherein the market data comprises consumer demographic data for the market and wherein the step of revising the consumer liking data comprises weighting the consumer liking data based upon the market data.

57. The method of claim 55, wherein the market data comprises sales data or consumer behavior data.

58. The method of claim 55, further comprising identifying a wine product having a high consumer liking indication for consumers of wine obtained from the market, and targeting a promotion of the wine product to said consumers.

59. The method of claim 58, wherein the step of targeting a promotion of the wine product to said consumers comprises at least one of: advertising the wine product, discounting the price of the wine product and identifying the wine product within a display.

60. The method of claim 55, further comprising determining a selection of wines in the market based upon the identified wine attributes.

61. A method of recommending a wine product to a wine consumer, the method comprising the steps of:
for a plurality of wines, determining for each wine a wine attribute profile to produce wine attribute profile data for the plurality of wines;
identifying a plurality of segments of consumers according to a plurality of consumer criteria;
obtaining data from the segments of consumers for the plurality of wines to produce consumer liking data, the consumer liking data for each consumer being a liking indication for at least a subset of the plurality of wines;
statistically evaluating the wine attribute profile data and the consumer liking data to identify wine attributes corresponding to wines having high consumer liking indications for each of the plurality of segments;
obtaining consumer characteristic data from the consumer to determine a consumer characteristic; and
recommending a wine product to the consumer based upon the consumer characteristic and the identified wine liking indications.

62. The method of claim 61, wherein the step of obtaining consumer characteristic data comprises querying the consumer.

63. The method of claim 61, wherein the step of obtaining consumer characteristic data comprises providing an interactive media and obtaining the consumer characteristic data via the interactive media.

64. The method of claim 6.1, wherein the step of recommending a wine product comprises identifying each of the plurality of wine products with a corresponding at least one of the plurality of segments.

65. The method of claim 64, wherein the step of identifying comprises coding the wine product.

66. The method of claim 64, wherein the step of identifying comprises coding at least one of a price tag and a shelf talker.

67. A method of identifying wines having similar liking characteristics to a consumer comprising the steps of:
for a plurality of wines, determining for each wine a wine attribute profile to produce wine attribute profile data for the plurality of wines;
identifying a segment of consumers according to at least one consumer criteria;
obtaining data from the segment of consumers for the plurality of wines to produce consumer liking data, the consumer liking data for each consumer being a liking indication for at least a subset of the plurality of wines;
statistically evaluating the wine attribute profile data and the consumer liking data to identify wine attributes corresponding to wines having high consumer liking indications for the segment;
wherein the predicted liking relationships between wines are visually identified.

68. The method of claim 67 wherein the predicted liking relationships are graphically depicted.

69. The method of claim 68 wherein the graphical depiction is a map.

70. The method of claim 67 wherein the predicted liking relationships are visually identified by means of a code selected from the group consisting of color codes, number codes, letter codes, graphic codes and iconic codes.

71. A method of identifying wines having similar liking characteristics to a consumer comprising the steps of:
for a plurality of wines, determining for each wine a wine attribute profile to produce wine attribute profile data for the plurality of wines;
identifying a segment of consumers according to at least one consumer criteria;
obtaining data from the segment of consumers for the plurality of wines to produce consumer liking data, the consumer liking data for each consumer being a liking indication for at least a subset of the plurality of wines;
statistically evaluating the wine attribute profile data and the consumer liking data to identify wine attributes corresponding to wines having high consumer liking indications for the segment;
wherein the wine attribute profile data and consumer liking data are visually identified.

72. The method of claim 71 wherein the wine attribute profile data and consumer liking data are graphically depicted.

73. The method of claim 72. wherein the graphical depiction is a map.

74. The method of claim 71 wherein the wine attribute profile data and consumer liking data are visually identified by means of a code selected from the group consisting of color codes, number codes, letter codes, graphic codes and iconic codes.

75. A method of recommending a wine product to a wine consumer, the method comprising the steps of:
for a plurality of wines, determining for each wine a wine attribute profile to produce wine attribute profile data for the plurality of wines;
identifying a plurality of segments of consumers according to a plurality of consumer criteria;
obtaining data from the segments of consumers for the plurality of wines to produce consumer liking data, the consumer liking data for each consumer being a liking indication for at least a subset of the plurality of wines
statistically evaluating the wine attribute profile data and the consumer liking data to identify wine attributes corresponding to wines having high consumer liking indications for each of the plurality of segments of consumers; and
recommending a wine product to the consumer based upon the identified wine liking indications.

76. The method of claim 75, wherein the step of recommending a wine product comprises identifying each of the plurality of wine products with a corresponding at least one of the plurality of segments of consumers.

77. The method of claim 76, wherein the step of recommending a wine product comprises visually identifying the product.

78. The method of claim 77 wherein the relationship between multiple wine products are graphically depicted.

79. The method of claim 78 wherein the graphical depiction is a map.

80. The method of claim 76 wherein the wine product is visually identified by means of a code selected from the group consisting of color codes, number codes, letter codes, graphic codes and iconic codes.
